(19) United States
(12) Patent Application Publication
(10) Pub. No.: US 2016/0212428 A1
(43) Pub. Date: Jul. 21, 2016

(54) SIGNAL PROCESSING APPARATUS AND METHOD INCLUDING QUANTIZATION OR INVERSE-QUANTIZATION PROCESS

(71) Applicant: MStar Semiconductor, Inc., Hsinchu Hsien (TW)

(72) Inventors: Sung-Wen WANG, Zhubei City (TW); Yi-Shin TUNG, Zhubei City (TW)

(21) Appl. No.: 14/996,299

(22) Filed: Jan. 15, 2016

(30) Foreign Application Priority Data
Jan. 15, 2015 (TW) 104101312

(51) Int. Cl. H04N 19/126; H04N 19/61; H04N 19/593; H04N 19/625; H04N 19/18; H04N 19/132

(52) U.S. Cl. CPC H04N 19/126; H04N 19/18; H04N 19/132; H04N 19/593; H04N 19/625; H04N 19/619

(57) ABSTRACT

A signal processing apparatus includes a memory and an expanding unit. The memory stores a plurality of initial coefficients. The expanding unit maps N initial coefficients among the coefficients to a quantization table, as N reference quantization weights, where N is a positive integer greater than 2. The N reference quantization weights are not aligned in the quantization table. The expanding unit generates the target quantization weight, by interpolation, according to the N reference quantization weights and respective distances between a target quantization weight and the N reference quantization weights in the quantization table.

This application claims the benefit of Taiwan application Serial No. 104101312, filed Jan. 15, 2015, the subject matter of which is incorporated herein by reference.

### BACKGROUND OF THE INVENTION

1. Field of the Invention

The invention relates in general to a video encoding/decoding technology, and more particularly to a quantization technology in a video encoding/decoding process.

2. Description of the Related Art

Digital television broadcasting has matured and become popular with the ever-improving communication technologies. In addition to being transmitted through cables, digital television signals may be propagated in form of wireless signals via base stations or artificial satellites. To satisfy demands on enhanced image quality and reduced transmission data amount, a transmitter end usually encodes and decompresses audio/video signals to be transmitted. Correspondingly, a receiver end needs to correctly decode and decompress the received signals in order to restore the audio/video signals.

FIG. 1(A) shows a partial functional block diagram of a video encoding system. An intra-prediction module 12 performs an intra-prediction process on image blocks in a video frame to generate a luminance residual matrix. The luminance residual matrix selected by the intra-prediction module 12 is provided to a discrete cosine transform (DCT) module 14 for a DCT process to generate a DCT coefficient matrix. To further reduce the data amount, a secondary transformation module 16 performs a secondary transform on low-frequency components in the DCT coefficient matrix. The low-frequency components having undergone the secondary transform and other high-frequency DCT coefficients that have not been processed by the secondary transform are recombined at a quantization module 18, which then performs a quantization process.

Thus, a quantization table is needed for the quantization process, stored in a memory 15. The quantization table is a quantization weight matrix, which has a size equal to that of the DCT coefficient matrix. If the size of the DCT coefficient matrix outputted by the DCT module 14 is N×N, the size of the quantization table is also N×N. To reduce the memory space, certain video encoding systems having quantization tables with larger sizes (e.g., 16×16 or 32×32) adopt the architecture shown in FIG. 1(B) instead. In such architecture, the memory module 15 stores a smaller coefficient matrix (e.g., 4×4 or 8×8) but not a complete quantization table. When the quantization module 18 needs the quantization table, an expanding unit 17 expands the small-sized coefficient matrix into a large-sized quantization table.

Two common methods for expanding the small-sized coefficient matrix are flat padding and bilinear interpolation. The flat padding approach has a lower complexity level and provides rougher expansion results. In contrast, the bilinear interpolation approach provides a good interpolation effect but has a higher complexity level.

### SUMMARY OF THE INVENTION

The invention is directed to a signal processing apparatus and a signal processing method. In the signal processing apparatus and the signal processing method of the present invention, interpolation is performed on N reference quantization weights that are not arranged on a straight line, and weighted values used for the interpolation are determined according to approximate distances of the quantization weights. Compared to uniformed units of interpolation, the signal processing apparatus and the signal processing method of the present invention provide more precise interpolation results. On the other hand, as approximate distances among quantization weights are estimated instead of precisely calculating area ratios, the signal processing apparatus and the signal processing method of the present invention have a lower calculation complexity than that of bilinear interpolation.

A signal processing apparatus is provided according to an embodiment of the present invention. The signal processing apparatus includes a memory and an expanding unit. The memory stores a plurality of initial coefficients. The expanding unit maps N initial coefficients among the coefficients to a quantization table, as N reference quantization weights, where N is a positive integer greater than 2. These N reference quantization weights are arranged in a way that all the N reference quantization weights are not aligned on a straight line in the quantization table. The expanding unit generates the target quantization weight according to the N reference quantization weights and respective approximate distances between a target quantization weight (to be determined) and the N reference quantization weights in the quantization table, by interpolation.

A signal processing method that expands a quantization table using a plurality of initial coefficients is provided according to another embodiment of the present invention. N initial coefficients among the coefficients are mapped to the quantization table to serve as N reference quantization weights. N is a positive integer greater than 2. The N reference quantization weights are arranged in a way that all these N reference quantization weights are not aligned on a same straight line in the quantization table. The target quantization weight is generated, by interpolation, according to the N reference quantization weights and the respective approximate distances between a target quantization weight to be determined and the N reference quantization weights in the quantization table.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1(A) and FIG. 1(B) are partial functional block diagrams of typical video encoding systems;

FIG. 2 is a functional block diagram of a video encoding apparatus according to an embodiment of the present invention;

FIG. 3(A) is an example of a corresponding relationship between an initial matrix and a quantization table; FIG. 3(B) is an example of an interpolation result generated by an expanding unit according to an embodiment of the present invention;

FIG. 4(A) and FIG. 4(B) are a coordinate assigning rule that realizes the weighted value assigning rule in FIG. 3(B) and a corresponding virtual code of, respectively;

FIG. 5 is examples of polygonal regions that may be adopted according to an embodiment of the present invention; and

FIG. 6 is a flowchart of a signal processing method according to an embodiment of the present invention.

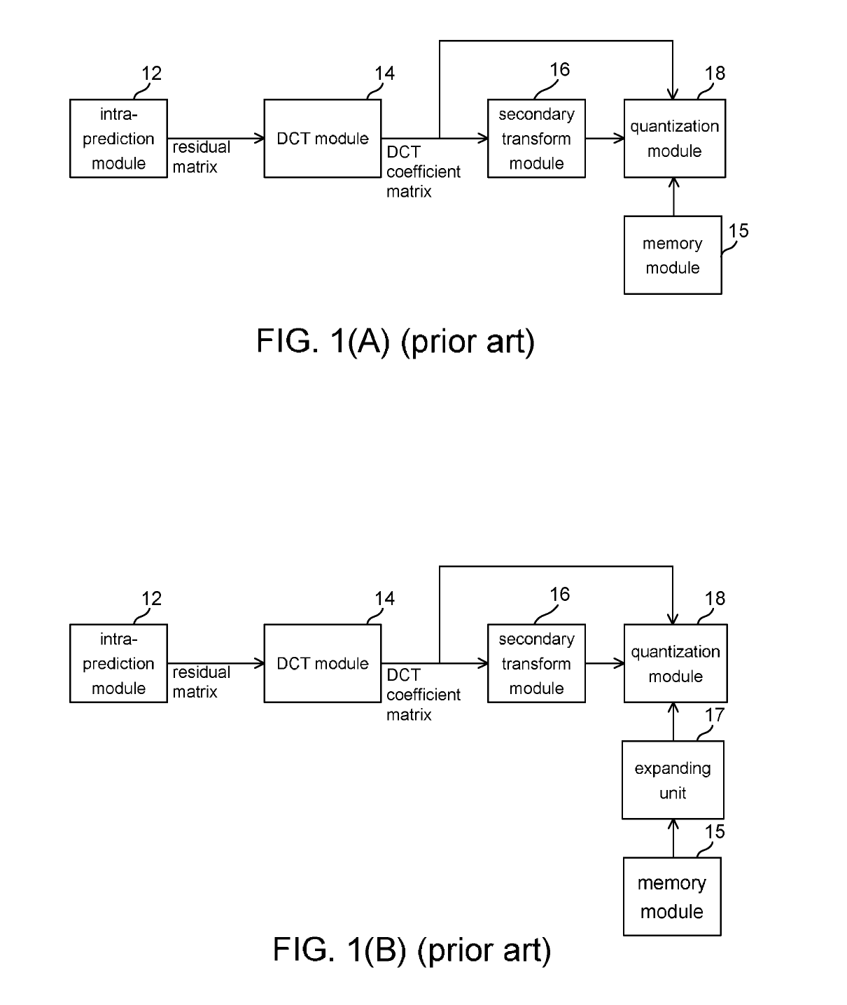

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

The concept of the present invention is applicable to various signal processing apparatuses involving quantization or inverse quantization processes (i.e., processes where a quantization table is utilized), e.g., a video encoding/decoding system based on digital audio video coding standard (AVS). For illustration purposes, the embodiments below are illustrated by taking a video encoding apparatus as an example. It should be noted that the scope of the present invention is not limited to the above example. Through the description below, one person skilled in the art can understand that, without departing from the spirit of the present invention, there are other various circuit configurations and elements that can be utilized to realize the concept of the present invention.

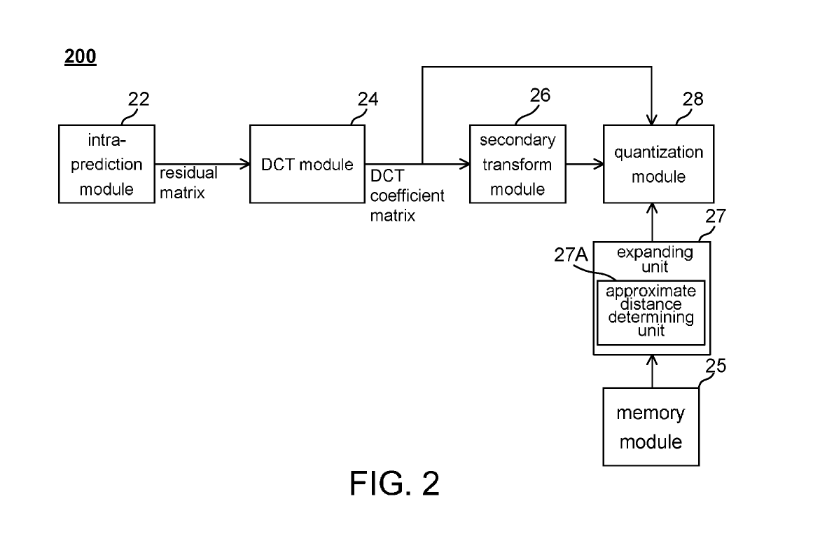

FIG. 2 shows a functional block diagram of a video encoding system according to an embodiment of the present invention. A video encoding apparatus 200 includes an intra-prediction module 22, a discrete cosine transform (DCT) module 24, a memory module 25, a secondary transform module 26, an expanding unit 27 and a quantization module 28. In practice, the video encoding apparatus 200 may be an independent unit, or may be integrated in a larger video processing system. The intra-prediction module 22 performs an intra-prediction process on image blocks in a video frame to generate a corresponding luminance residual matrix. The luminance residual matrix outputted by the intra-prediction module 22 is provided to the DCT module 24, which then performs a DCT process to generate a DCT coefficient matrix. The secondary transform module 26 performs a secondary transform on low-frequency components in the DCT coefficient matrix. The low-frequency components having undergone the secondary transform and other high-frequency DCT coefficients that have not been processed by the secondary transform are recombined at the quantization module 28, which then performs a quantization process. The memory module 25 stores a plurality of initial coefficients. The expanding unit 27 expands an initial matrix consisted of the initial coefficients into a quantization table having a larger size for the use of the quantization module 28.

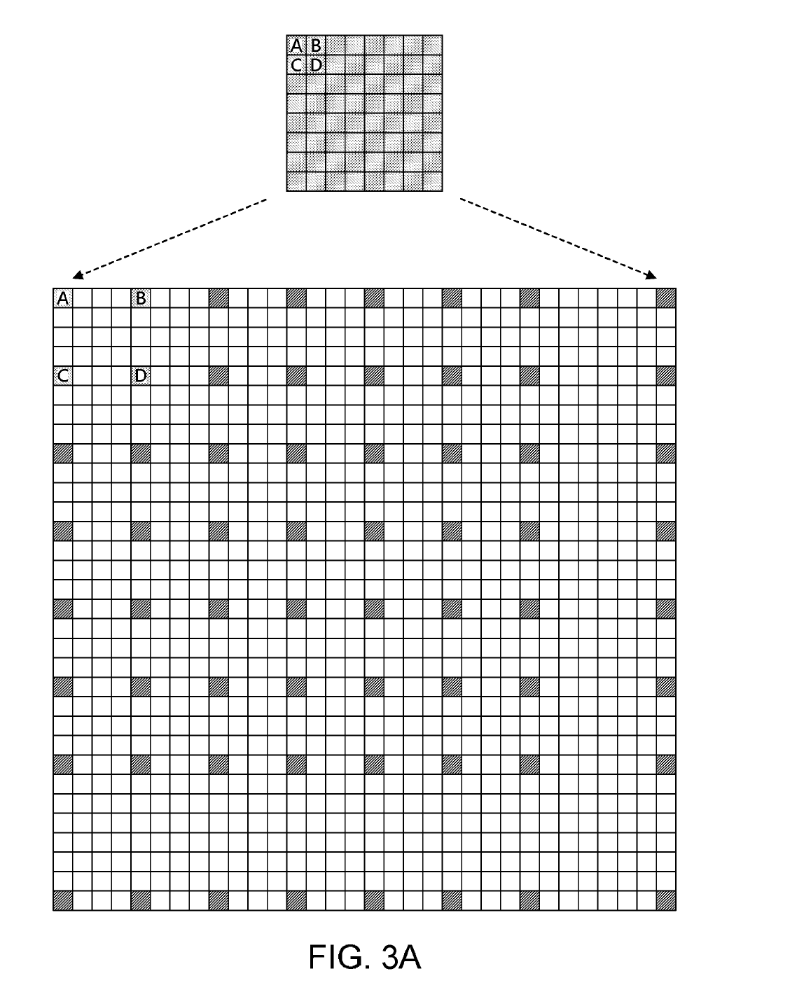

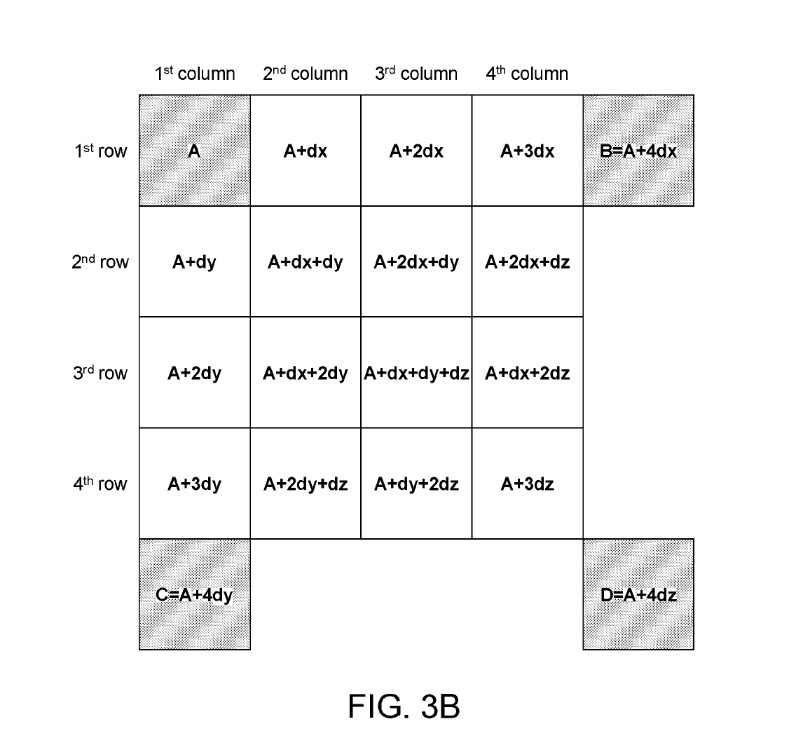

FIG. 3(A) shows an example of a corresponding relationship between an initial matrix and a quantization table. In this example, the initial matrix has a size of 8×8, and the quantization table has a size of 32×32. Further, original 8×8 initial coefficients in the initial matrix are separate and mapped to the quantization table in a distributed manner to become sixty-four (64) reference quantization weights (the shaded parts). In practice, these sixty-four (64) reference quantization weights may be partially the same or may be completely different. The non-shaded elements in the quantization table may be partially or entirely generated by the expanding unit 27 according to the 8×8 reference quantization weights.

Taking the reference quantization weights A to D in FIG. 3(A) for example, FIG. 3(B) shows an example of an interpolation result generated by the expanding unit 27 to explain operations of the expanding unit 27. In this example, the reference quantization weight A is taken by the expanding unit 27 as a basic quantization weight, and the expanding unit 27 interpolates the reference quantization weights A to D to generate fifteen quantization weights at the lower right region of the basic quantization weight A. These fifteen quantization weights are generated through interpolation by adding respective and individual adjustment amounts to the basic quantization weight A. The expanding unit 27 includes an approximate distance determining unit 27A that determines respective approximate distances between a target quantization weight and the reference quantization weights A to D. The determination results of the approximate distance determining unit 27A are the reference for determining the above adjustment amounts. Associated details are given below.

A difference (4*dx) between the reference quantization weight B and the basic quantization weight A, a difference (4*dy) between the reference quantization weight C and the basic quantization weight A, and a difference (4*dz) between the reference quantization weight D and the basic quantization weight A can be learned in advance. The differences dx, dy and dz may be positive or negative. In the embodiment, the expanding unit 27 calculates the adjustment amounts using the differences dx, dy and dz as the basic units. And the target quantization weight to be determined can be represented as:

A+a₁*dx+a₂*dy+a₃*dz equation (1)

In equation (1), the weighted values a₁, a₂ and a₃ are determined by the determination results of the approximate distance determining unit 27A. The weighted value a₁ gets larger as the distance of the target quantization weight in the quantization table gets shorter to the reference quantization weight B, i.e., the reference quantization weight B is caused to have a greater effect on the target quantization weight. Similarly, the weighted value a₂ gets larger as the distance of the target quantization weight in the quantization table gets shorter to the reference quantization weight C, and the weighted value a₃ gets larger as the distance of the target quantization weight in the quantization table gets shorter to the reference quantization weight D. Based on normalization considerations, a sum of the weighted values a₁, a₂ and a₃ may be designed as a constant value, and the output signals of the approximate distance determining unit 27A may directly be the weighted values a₁, a₂ and a₃.

It is seen from FIG. 3(B) that, the three quantization weights located at the 1^{st} row and the 2^{nd} to 4^{th} columns sequentially get closer to the reference quantization weight B, and so the respective weighted values a₁ gradually increase (respectively equal to 1, 2 and 3). As the three quantization weights located at the 1^{st} column and the 2^{nd} to 4^{th} rows sequentially get closer to the reference quantization weight C, the respective weighted values a₂ also gradually increase (respectively equal to 1, 2 and 3). Further, taking the quantization weights located at the 4^{th} column and the 1^{st} to 4^{th} rows for example, the respective weighted values a₃ gets larger (respectively equal to 1, 2 and 3) as these quantization weights get closer to the reference quantization weight D. To reduce the calculation complexity level, the weighted values a₁, a₂ and a₃ may be designed as integers. For example, assuming that the quantization weights at the 1^{st} row and the 4^{th} column are regarded as being spaced from the basic quantization weight B by one unit length, the approximate distance determining unit 27A may also regard the quantization weights located at the 2^{nd} row and the 4^{th} column as being spaced from the basic quantization weight B by a distance of one unit length instead of by a distance of 1.414 unit lengths. Similarly, the approximate distance determining unit 27A may regard the quantization weights located at the 3^{rd} row and the 4^{th} column as being spaced from the quantization weight B by two unit lengths.

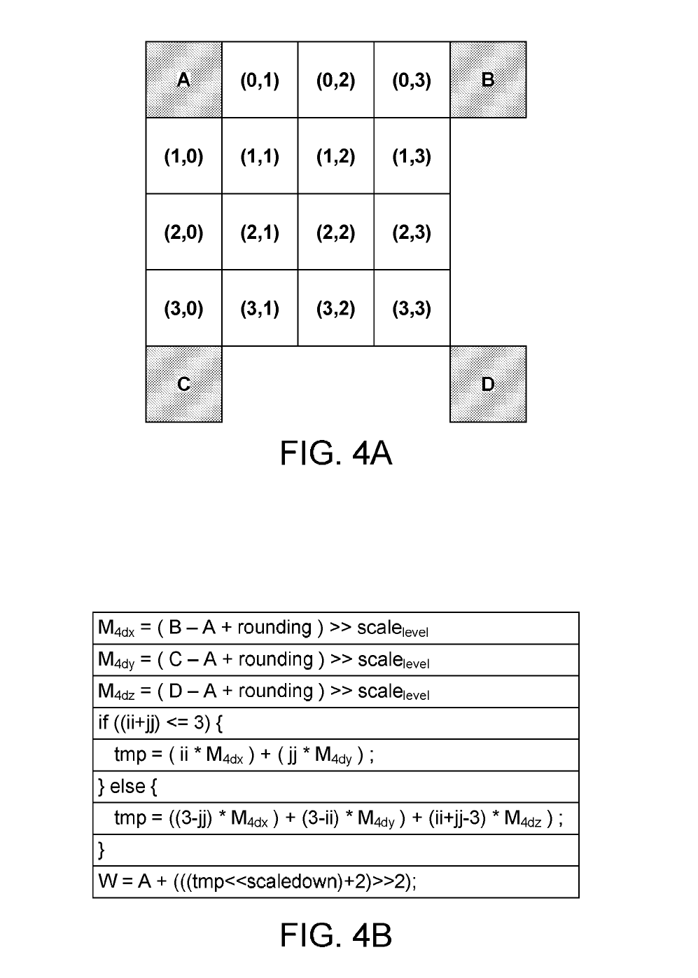

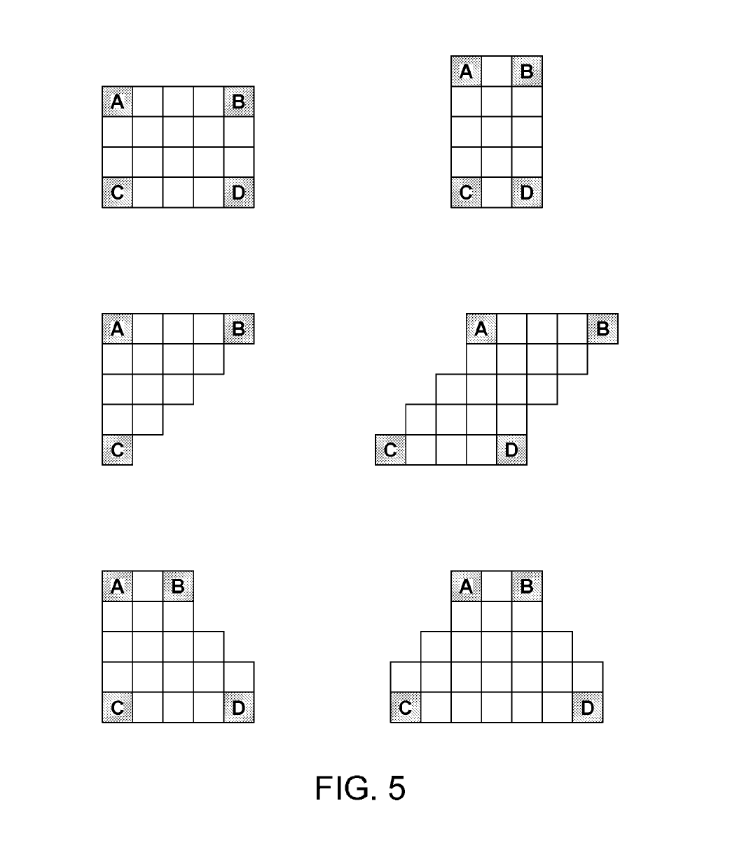

In practice, the approximate distance determining unit 27A may in real-time calculate the weighted values a₁, a₂ and a₃ according to coordinates of the target quantization weight in the quantization table. FIG. 4(A) and FIG. 4(B) show a coordinate assigning rule that realizes the weighted value assigning rule in FIG. 3(B) and a corresponding virtual code, respectively. Each target quantization weight is assigned with coordinates (jj, ii).

It should be noted that, the main concept of the present invention is not limited to the weighted value arrangement method shown in FIG. 3(B). The main concept relies on interpolating the N reference quantization weights that are not aligned in the quantization table, and also relies on determining weighted values for the interpolation according to approximate distances. N is a positive integer greater than 2, e.g., 3 or 4. All these N reference quantization weights form a polygonal region in the quantization table as all of them put together are not aligned. Also, the target quantization weight to be determined is located in that polygonal region. In practice, one quantization table may be divided into multiple polygonal regions having different shapes. In the above situation, given appropriate reference quantization weights are determined for each polygonal region, corresponding interpolation results can be obtained.

Compared to flat padding, the expanding unit according to the present invention provides more precise interpolation results. On the other hand, as only approximate distances between the quantization weights need to be estimated instead of precisely calculating area ratios of the quantization weights, the calculation complexity level of the expanding unit according to the present invention is lower than that of bilinear interpolation.

In one embodiment, the memory module 25 stores a basic initial coefficient among the N initial coefficients, as well as differences between the other (N−1) initial coefficients and the basic initial value. For example, the memory module 25 may store the basic initial coefficient A and the differences dx, dy and dz at the same memory position. When the expanding unit 27 calculates the fifteen quantization weights at the lower right of the basic quantization weight A, it only fetches the basic initial coefficient A and the differences dx, dy and dz from the memory module 25, without needing to retrieve data associated with the initial coefficients B to D from the memory 25. With the weighted values a₁, a₂ and a₃ provided by the approximate distance determining unit 27A, the expanding unit 27 can then calculate the fifteen quantization weights at the lower right of the basic quantization weight A. In practice, the plurality of initial coefficients for generating the quantization table may be known a priori, and so it is possible to store the above data in the memory 25 in advance. In the above situation, the operations of interpolation according to the present invention can be implemented using simple addition and multiplication circuits or logic elements.

It should be noted that, the scope of the present invention covers various kinds of image data matrices as the input signal of the quantization module 28 instead of limiting the input signal to be a DCT coefficient matrix and/or a secondary transform result of the DCT coefficient matrix. However, in a situation where the input signal of the quantization module 28 is a DCT coefficient matrix, the low-frequency component closest to the upper-left corner in the DCT coefficient matrix is most critical. Thus, the expanding unit 27 may select the initial coefficient corresponding to the reference quantization weight closest to the upper-left corner of the quantization table as the above basic initial coefficient.

In one embodiment, when there is a demand for a simple calculation process and shortened calculation time, the expanding unit 27 may selectively combine flat padding and the foregoing interpolation mechanism. Taking FIG. 3(B) for example, the expanding unit 27 first calculates one of the fifteen quantization weights to be determined according to the foregoing interpolation mechanism, and then fills the calculated result into a part or all of the fifteen positions. In the above situation, the differences dx, dy and dz in equation (1) may all be replaced by one of the three differences (e.g., dx) or an average of the three differences.

In another embodiment, the expanding unit 27 may generate a plurality of candidate quantization weights according to the N reference quantization weights by interpolation, and select only one from the candidate quantization weights as the target quantization weight.

In practice, the expanding unit 27 may be implemented as a fixed and/or programmable digital logic circuit, e.g., a programmable logic gate array, application-specific integrated circuit, microcontroller, microprocessor, digital signal processor and other necessary circuits. Further, the scope of the present invention is not limited to a specific storage mechanism. The memory module 25 may include one or multiple volatile or non-volatile memory devices, e.g., an SRAM, ROM, magnetic and/or optic memory and flash.

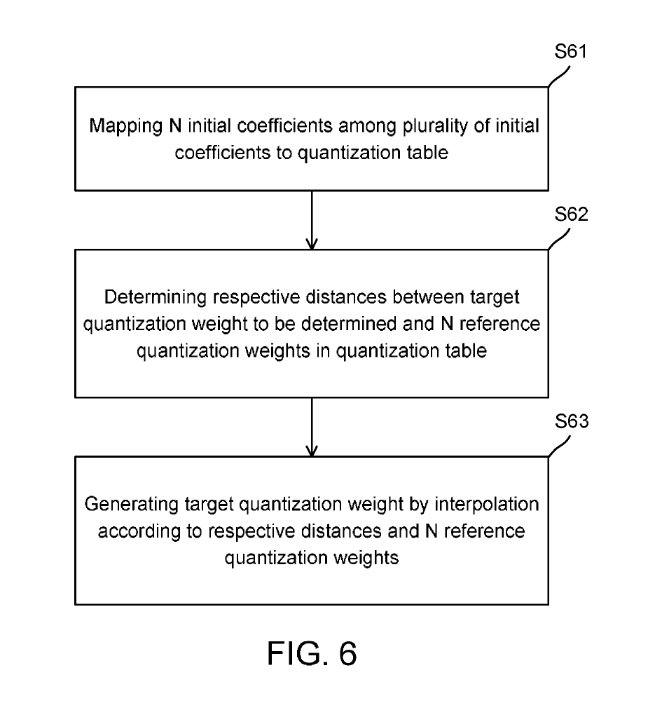

A signal processing method for expanding a quantization table using a plurality of initial coefficients is provided according to another embodiment of the present invention. FIG. 6 shows a flowchart of the signal processing method. In step S61, N initial coefficients among the initial coefficients are mapped to the quantization table to serve as N reference quantization weights. N is a positive integer greater than 2. The N reference quantization weights are arranged in a way that they are not aligned on a same straight line in the quantization table. In step S62, respective distances between a target quantization weight and the N reference quantization weights in the quantization table are determined. In step S63, the target quantization weight is generated, by interpolation, according to the respective distances and the N reference quantization weights.

One person skilled in the art can understand that, the operation details and variations in the description associated with the video encoding apparatus 200 are applicable to the signal processing method in FIG. 6, and shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A signal processing apparatus, comprising:
a memory, storing a plurality of initial coefficients; and
an expanding unit, mapping N initial coefficients among the plurality of initial coefficients to a quantization table to serve as N reference quantization weights, N being an integer greater than 2; wherein the N reference quantization weights are arranged in a way that all the N reference quantization weights are not aligned in the quantization table, and the expanding unit generates the target quantization weight, by interpolation, according to the N reference quantization weights and respective distances between a target quantization weight and the N reference quantization weights in the quantization table.

2. The signal processing apparatus according to claim 1, wherein the memory stores a basic initial coefficient among the N number of the initial coefficients and respective differences between the remaining (N−1) initial coefficients and the basic initial coefficient; when generating the target quantization weight, the expanding unit obtains the basic initial coefficients and the (N−1) differences from the memory, and assigns weighted values to the (N−1) differences respectively according to the respective distances between the target quantization weight and the N reference quantization weights.

3. The signal processing apparatus according to claim 2, wherein, one of the initial coefficients is selected as the basic initial coefficient in a way that the selected initial coefficient corresponds to the reference quantization weight that is closest to an upper-left corner of the quantization table, among the N reference quantization weights.

4. The signal processing apparatus according to claim 1, wherein the expanding unit fills the target quantization weight to a plurality of positions in the quantization table.

5. The signal processing apparatus according to claim 1, wherein the expanding n unit generates a plurality of candidate quantization weights by interpolation according to the N reference quantization weights, and selects one of the candidate quantization weights as the target quantization weight.

6. The signal processing apparatus according to claim 1, wherein the integer N is equal to 3 or 4.

7. A signal processing method, for expanding a quantization table using a plurality of initial coefficients, comprising:
a) mapping N initial coefficients among the plurality of initial coefficients to a quantization table to serve as N reference quantization weights, N being an integer greater than 2; wherein the N reference quantization weights are arranged in a way that the N reference quantization weights are not aligned in the quantization table; and
b) generating the target quantization weight, by interpolation, according to the N reference quantization weights and respective distances between a target quantization weight and the N reference quantization weights in the quantization table.

8. The signal processing method according to claim 7, wherein a basic initial coefficient among the N initial coefficients and respective differences between the remaining (N−1) initial coefficients and the basic initial coefficient are provided in advance; step (b) comprises: when generating the target quantization weight, assigning weighted values to the (N−1) differences respectively according to the respective distances between the target quantization weight and the N reference quantization weights.

9. The signal processing method according to claim 8, wherein, one of the initial coefficients is selected as the basic initial coefficient in a way that the selected initial coefficient corresponds to the reference quantization weight that is closest to an upper-left corner of the quantization table, among the N reference quantization weights.

10. The signal processing method according to claim 7, further comprising:
after the target quantization weight is determined, filling the target quantization weight to a plurality of positions in the quantization table.

11. The signal processing method according to claim 7, wherein step (b) comprises:
generating a plurality of candidate quantization weights by interpolation according to the N reference quantization weights, and selecting one of the candidate quantization weights as the target quantization weight.

12. The signal processing method according to claim 7, wherein the integer N is equal to 3 or 4.
